(19) United States
(12) Patent Application Publication
(10) Pub. No.: US 2017/0006038 A1
(43) Pub. Date: Jan. 5, 2017

(54) METHOD AND DEVICE FOR VERIFYING PERMISSION

(71) Applicant: Xiaomi Inc., Beijing (CN)

(72) Inventors: Yanlu Zhang, Beijing (CN); Mingjun Yin, Beijing (CN); Ziguang Gao, Beijing (CN)

(73) Assignee: Xiaomi Inc., Beijing (CN)

(21) Appl. No.: 15/266,359

(22) Filed: Sep. 15, 2016

Related U.S. Application Data
(63) Continuation of application No. PCT/CN2015/093906, filed on Nov. 5, 2015.

(30) Foreign Application Priority Data
Nov. 14, 2014 (CN) 201410646289.4

(51) Int. Cl. H04L 29/06

(52) U.S. Cl. CPC H04L 63/10; H04L 63/12; H04W 84/20

(57) ABSTRACT

Methods and apparatus for verifying permission between a master terminal device, a slave device, and a verification server are disclosed to control the slave device by the master terminal device. The verification of permission may be based on physical proximity between the master terminal device and the slave device such that verification signal output by the slave device may be directly observable by the master terminal device.

This application is a continuation of International Patent Application No. PCT/CN2015/093906, filed on Nov. 5, 2015, which claims the benefit of prior Chinese Application No. 201410646289.4 filed on Nov. 14, 2014, both of which are hereby incorporated by reference in their entireties.

### TECHNICAL FIELD

The present disclosure relates to the field of communication technology, and more particularly, to a method and a device for verifying permission.

### BACKGROUND

In application of wireless Internet of things, verification and establishment of permission for one smart device (and its owner) to control various other smart devices is a critical security issue. In related art, the verification and establishment of permission may be based on an assumption that two devices that have physical access to each other must have obtained some form of security clearance. Thus control permission may be give after verifying that the device seeking control and the device to be controlled are indeed physically co-located. In particularly, each device to be controlled may be labeled with a two-dimension graphic code which a device seeking control may access. The device seeking control may thus prove to a verification server that it is near the device to be controlled by physically obtaining the graphic code (scanning or photographing) and sending the code to the verification server. If the code matches the record maintained by the verification server, then the permission to control may be granted. However, the two-dimension graphic code method is static (and thus not very secure) and inconveniently requires scanning or photographing a graphic code that need to be attached to the surface of smart devices.

### SUMMARY

Embodiments of the present disclosure provide methods and devices for verifying permission. This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, a method for obtaining permission to control a slave device by a master terminal from a verification server is disclosed. The method includes sending by the master terminal a request for permission to control the slave device to the verification server via a current account of the master terminal registered with the verification server after the master terminal has established a communication connection with the slave device; receiving a verification operation prompt by the master terminal from the verification server informing the master terminal to record a verification signal to be output by the slave device; executing a verification operation comprising at least recording by the master terminal the verification signal currently output by the slave device as a verification information; and reporting the verification information to the verification server, wherein the verification signal to be output by the slave device is prescribed by the verification server and dynamically controllable by the slave device.

In another embodiment, a method for verifying, by a verification server, permission for controlling a slave device by a master terminal is disclosed. The method includes receiving a request to control the slave device sent by the master terminal via a current account of the master terminal with the verification server after establishing a communication connection with the master terminal; and sending a verification operation prompt to the master terminal for recording a verification signal output by the slave device, wherein the verification signal to be output by the slave device is prescribed by the verification server and dynamically controllable by the slave device.

In another embodiment, a method for giving permission by a slave device to be controlled by a master terminal via a verification server is disclosed. The method includes receiving an instruction from the verification server for outputting a verification signal; and outputting the verification signal according to the instruction, wherein the verification signal is prescribed by the verification server and dynamically controllable by the slave device.

In another embodiment, a method for obtaining permission to control a slave device by a master terminal from a verification server is disclosed. The method includes receiving a verification operation prompt sent from the verification server prompting a user of the master terminal to perform at least one of conducting a physical manipulation of the slave device or causing a generation of an input signal to the slave device, wherein each of the physical manipulation and the input signal is prescribed by the verification server and electronically detectable by the slave device.

In another embodiment, a method for verifying by a verification server permission for controlling a slave device by a master terminal is disclosed. The method includes receiving a request to control the slave device sent by the master terminal via a current account of the master terminal with the verification server after establishing a communication connection with the master terminal; and sending a verification operation prompt to the master terminal for prompting a user of the master terminal to perform at least one of conducting a physical manipulation of the slave device or causing a generation of an input signal to the slave device, wherein each of the physical manipulation and the input signal is prescribed by the verification server and electronically detectable by the slave device.

In another embodiment, a method for giving permission by a slave device to be controlled by a master terminal via a verification server is disclosed. The method includes, receiving an instruction from the verification server for monitoring at least one of a physical manipulation of the slave device or an input signal into the slave device; detecting the by the slave device via at least one sensor the at least one of the physical manipulation or the input signal; and sending information about the detected at least one of the physical manipulation or the input signal to the verification server, wherein each of the physical manipulation and the input signal is prescribed by the verification server and electronically detectable by the at least one sensor of the slave device.

In yet another embodiment, a terminal device seeking permission to control a slave device is disclosed. The terminal device includes processor; a memory configured to store an instruction executable by the processor; wherein the processor is configured to cause the terminal to executing a verification operation comprising at least recording by the terminal a verification signal currently output on the slave device as a verification information; and reporting the verification information to a verification server, wherein the verification signal to be output by the slave device is prescribed by the verification server and dynamically controllable by the slave device.

It is to be understood that both the foregoing general description and the following detailed description are illustrative and explanatory only and are not restrictive of the disclosure, as claimed.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 illustrates the context in which the method and apparatus disclosed herein may apply.

FIG. 2 is a flow chart showing a method for verifying permission applied to a master terminal;

FIG. 3 is a flow chart showing a specific method for verifying permission applied to a mobile phone;

FIG. 4 is a flow chart showing a method for verifying permission as applied to a verification server;

FIG. 5 is a flow chart showing yet another method for verifying permission as applied to a verification server;

FIG. 6 is a flow chart showing a method for verifying permission as applied to a slave device;

FIG. 7 is a flow chart showing a method for verifying permission as applied to a system comprising a master terminal, a slave device, and a verification server;

FIG. 8 is a block diagram showing a device for verifying permission according to an illustrative embodiment;

FIG. 9 is a block diagram showing another device for verifying permission according to an illustrative embodiment;

FIG. 10 is a block diagram showing yet another device for verifying permission according to an illustrative embodiment;

FIG. 11 is a block diagram showing a terminal device for verifying permission according to an illustrative embodiment;

FIG. 12 is a block diagram showing a server device for verifying permission according to an illustrative embodiment.

### DETAILED DESCRIPTION

Reference will now be made in detail to illustrative embodiments, examples of which are illustrated in the accompanying drawings. The following description refers to the accompanying drawings in which the same numbers in different drawings represent the same or similar elements unless otherwise represented. The implementations set forth in the following description of illustrative embodiments do not represent all implementations consistent with the disclosure. Instead, they are merely examples of devices and methods consistent with aspects related to the disclosure as recited in the appended claims.

Terms used in the disclosure are only for purpose of describing particular embodiments, and are not intended to be limiting. The terms “a”, “said” and “the” used in singular form in the disclosure and appended claims are intended to include a plural form, unless the context explicitly indicates otherwise. It should be understood that the term “and/or” used in the description means and includes any or all combinations of one or more associated and listed terms.

It should be understood that, although the disclosure may use terms such as “first”, “second” and “third” to describe various information, the information should not be limited herein. These terms are only used to distinguish information of the same type from each other. For example, first information may also be referred to as second information, and the second information may also be referred to as the first information, without departing from the scope of the disclosure. Based on context, the word “if” used herein may be interpreted as “when”, or “while”, or “in response to a determination”.

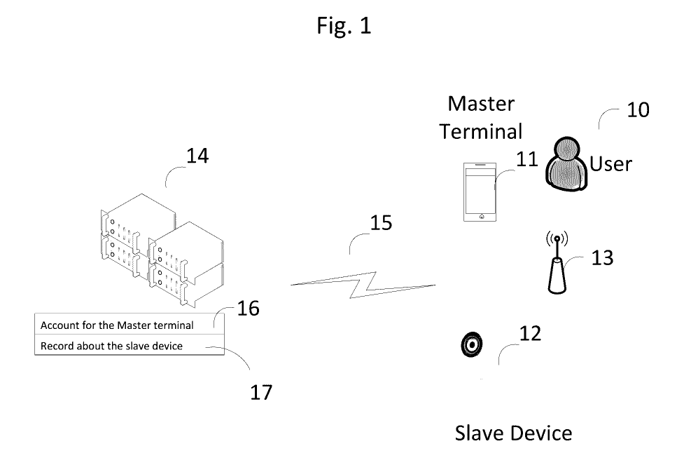

By way of introduction, FIG. 1 illustrates a context where the method and apparatus disclosed herein may be applied. User 10 may attempt to use a terminal device (herein referred to as “master terminal”) to control another electronic device 12 (herein referred to as “slave device”). The control commands may be sent from the master terminal to the slave device wirelessly. For security reasons, the master terminal may need to first obtain permission to control the slave device. The permission management may be provided by a verification server 14 in communication with the master terminal 11 via a communication network 15. The master terminal may pre-establish an account 16 with the verification server. The slave device may also be in communication and pre-registered with the verification server 14. The verification server 14 thus maintains a profile of the slave device in terms of at least its capability to output some verification signal (herein also referred to as “physical property”). For example, the verification server may be aware of the sensors, buttons, indicators, audio output, and display screen capabilities of the slave device. To obtain permission to control the slave device, the master terminal may first send a request to the verification server upon discovering the slave device (device discovery may be performed in various means. For example, the master terminal may perform device discovery via a wireless access point 13). The verification server may carry out a series of steps as detailed below to determine whether control should be granted to the master terminal. The verification procedure may be based on an assumption that if the master device has already obtained physical access to the slave device (for example, the master device is able to measure or observe the content of the display on the slave device or the user of the master device is able to push a button on the slave device), then it is safe to grant the master terminal permission to control. The verification process may thus be focused on determining that the master device (and its user) is indeed co-located with the slave device and has physical access to the slave device. The method and device described below is based on one or more dynamically controlled verification signals (or physical properties) output or displayed by the slave device rather than a static two-dimensional graphic code.

The verification methods and apparatus described below involve several concepts and terms. The term “verification operation prompt” refers to a message sent from the verification server informing or prompting the master terminal as to the verification operation that the master terminal or its user is expected to perform. The term “verification signal” refers to an active signal “output” by the slave device that may be observed or measured and recorded by the master device as one type of verification information. The term “output” may be interchangeably used with the term “display”. A verification signal may be broadly referred to as a “physical property” of the slave device. The term “verification operation” refers to the action that the master terminal needs to perform (such as observing and recording some prescribed verification signal or physical property of the slave device). In some alternative embodiments, the verification operation may also refer to some action that the slave device needs to perform (such as monitoring its sensors for physical manipulation of the slave device or input into the slave device). “Instruction” may be sent by the verification server to the slave device instructing the slave device to display or output certain prescribed verification signal or physical property. The term “verification information” refers to the information collected by either the master terminal or the slave device and sent to the verification server for verification.

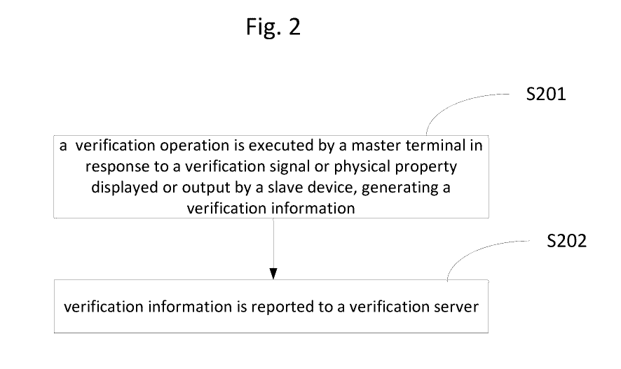

FIG. 2 is a flow chart showing a method for verifying permission according to an illustrative embodiment. The method may be used for verifying permission of a master terminal such as a mobile phone, a tablet, and a PC, to control a slave device. The method may include following steps.

In step S201, a verification operation is executed by the master terminal in response to a verification signal or physical property displayed or output in a slave device. Because the master terminal is in physical proximity to the slave device, the verification signal or physical property output or displayed in the slave device may be directly observed and input into and recorded in the master terminal. The input and recording of the observed verification signal or physical property is referred to as the verification operation. The verification signal or physical property information input into the master terminal acts as a verification information. Accordingly, by recording the verification signal or physical property information, the master terminal performs the verification operation. The verification signal or physical property output or displayed by the slave device may be one or more of a output or displayed random number, a output or displayed random character, a output or displayed graphic pattern, a color of an indicator light, the number of indicator lights, a flashing frequency of an indicator light, a voice output, a physical deformation and a physical displacement. For example, when the verification signal or physical property output or displayed in the slave device is a output or displayed random character, the master terminal may execute the verification operation by recording this random character. As another example, when the verification signal or physical property output or displayed in the slave device is the color of the indicator light, the master terminal may execute the verification operation by recording the observed color of the indicator light. These physical properties may be dynamic. For example, the random number output or displayed may change from time to time; and the color of the indicator may be varied.

In step S202, the verification information input into the master terminal is reported to the verification server via the communication network. For example, the color information of the indicator light on the slave device may be taken as the verification information and the master terminal sends the observed color of the indicator light to the verification server.

In one embodiment, the method may further include (1) sending a request for permission to control the slave device by the master terminal to the verification server via a current account of the master terminal with the verification server after the master terminal establishes an initial a communication connection with the slave device; and (2) receiving by the master terminal a verification operation prompt from the verification server informing the particular verification signal or physical property to be used as the verification information. In particular, upon receiving the request from the master terminal, the verification server may inform the mater terminal as to which verification signal or physical property output or displayed by the slave device to observe and report back.

In another embodiment, the method may further include: (1) receiving a verification result by the master terminal from the verification server after the verification server makes verification assessment according to the verification information sent by the master terminal; (2) establishing by the master terminal a control relationship between the current account of the master device and the slave device if the verification is successful; and (3) displaying a prompt on the master terminal indicating verification failure if the verification is not successful. The control relationship may be further stored in the verification server.

Those of ordinary skill in the art understand that in one variation of the embodiment above, the verification server, upon receiving binding request from the master terminal, may send a verification operation prompt for the user of the master terminal to perform some active manipulation on the slave device rather than simply recording some verification signal or physical property output or displayed by the slave device. The slave device may in turn sense the manipulation actually performed on it and send information about the actual manipulation to the verification server. In this variation, the manipulation information sensed by the slave device would be the verification information and it would be the slave device rather than the master terminal who report the verification information to the verification server in Step 202. For example, the verification server may prompt the user of the master terminal to press a button on the slave device some number of times. The slave device then will sense and record actual pressing of the button and report the number of presses to the verification server for verification.

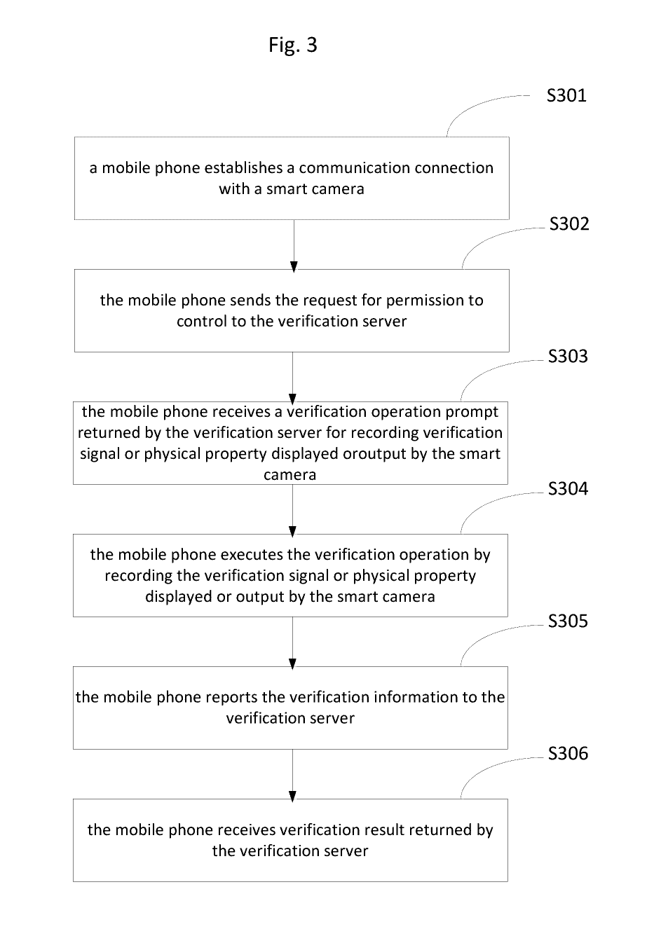

In one exemplary implementation, the master terminal may be a mobile phone and the slave device may be a smart camera. The mobile phone may attempt to obtain a permission to control the smart camera from the verification server. The method provided by the embodiment of FIG. 2 and its variation may be specifically implemented as shown in FIG. 3 through the following steps.

In step S301, the mobile phone establishes a communication connection with the smart camera via, for example, an application for the smart camera on the mobile phone. For another example, the mobile phone may discover the smart camera via the verification server or in a local area network (such as a Wi-Fi network). The mobile phone may also discover the smart camera by broadcasting device discovering messages or by other manners directly. In step S302, the mobile phone sends the request for control permission to the verification server. In step S303, the mobile phone receives the verification operation prompt from the verification server informing the mobile phone the verification signal or physical property of the smart camera to be observed and returned to the verification server. For example, the verification operation prompt may be “please input the number of flashing of the red indicator light”. In step S304, the mobile phone executes the verification operation by recording the observed verification signal or physical property output or displayed in the slave device. For example, the mobile terminal via the user (or its camera and image processing capabilities) observes flashing of the red indicator light on the smart camera, records (or receives as input from a user) the number of observed flashes. In step S305, the mobile phone reports the verification information, i.e., the number of observed red flashes, to the verification server via the communications networks such that the verification server may perform verification. In step S306, the mobile phone receives the verification result returned by the verification server after the verification server determine wither the verification information sent from the mater terminal matches the verification signal or physical property prescribed by the verification server. The control relationship between the current account and the slave device is established if the verification is successful; and a failure prompt is displayed if the verification fails.

In a variation of the embodiment above (for FIG. 3), the verification operation prompt received by the master terminal (Step S303) may be an active manipulation that the user of the master terminal is prescribed to perform on the smart camera in order to be verified. For example, the prompt may say “press the shutter 5 times within 2 seconds.” In this variation, the execution of the verification operation of Step S304 may be actual pressing of the shutter of the smart camera. Step S305 then would be performed by the smart camera rather than the master terminal in that the smart camera would monitor its shutter and record how it was pressed in certain duration as the verification information and report it to the verification server.

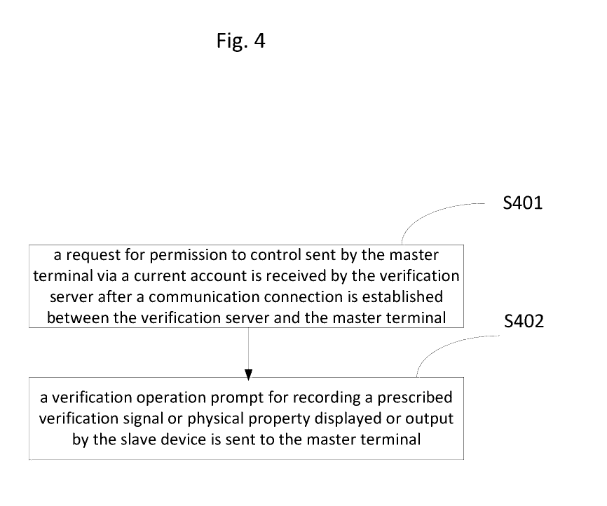

The same verification idea of FIG. 2 and FIG. 3 may be carried out from the verification server rather than the master terminal standpoint, as shown in the flow chart of FIG. 4. The verification server may be a cloud server, a router, etc. In step S401, a request for permission to control sent by the master terminal via its current account with the verification server is received by the verification server after a communication connection is established between the verification server and the master terminal. In step S402, a verification operation prompt for recording a prescribed verification signal or physical property of the slave device is sent to the master terminal. For example, after the request sent by the master terminal via the current account is received by the verification server, the information about the slave device is identified by the verification server. The verification server may examine the physical properties that the slave device may be instructed to display. The verification server then sends a verification operation prompt to the master terminal for recording at least one selected verification signal or physical property that can be output or displayed by the slave device. For example, the slave device may possess an indicator light, and a content of the verification operation prompt may be related to some observables of the indicator light. The slave device may additionally or alternatively possess a display screen, and the content of the verification operation prompt may additionally or alternatively include asking the master terminal to observe and record content output or displayed in the display screen of the slave device. In one variation of the Step S402 above, the slave device may have a physical button, and the content of the verification operation prompt may contain instruction for the user of the master terminal to press the button on the slave device in certain prescribed manner rather than recording a verification signal or physical property output or displayed by the slave device. In another variation of the Step S402, the slave device may have motion sensors and the content of the verification operation prompt may contain instruction for the user of the master terminal to actively move or shake the slave device in some prescribed manner rather than recording a verification signal or physical property output or displayed by the slave device. In another variation of the step S402, the slave device may have voice recognition capability and the content of the verification operation prompt may contain instruction to prompt the master device (or its user) to speak a certain prescribed word into the slave device.

In some embodiment, the method of FIG. 4 may further include sending by the verification server an instruction to the slave device for displaying the prescribed verification signal or physical property while sending the verification operation prompt to the master terminal for recording the verification signal or physical property to be output or displayed by the slave device. The sending of the instruction to the slave device and sending of the verification operation prompt to the master terminal does not need to be in any particular order as long as sufficient time is given to the master terminal to observe the instructed display of the prescribed verification signal or physical property by the slave device. Examples of instruction for displaying certain prescribed verification signal or physical property by the slave device may comprise but are not limited to an instruction for displaying numbers, an instruction for lighting up the indicator light, an instruction for producing a physical deformation of the slave device, an instruction for generating physical displacement of the slave device, and any combination thereof. Alternatively, for the variation that the user of the master device is prompted to perform active manipulation on or to the slave device (such as pressing the buttons on the slave deice or physically shake the slave device in certain prescribed manner or speak into the slave device) rather than recording verification signal or physical property output or displayed on the slave device, the verification server may send instruction to the slave device for monitoring actual manipulation being performed on the slave device (such as how was the button pressed or how was the slave device displaced or what was spoken into the slave device) rather than for displaying certain verification signal or physical property. Those of ordinary skill in the art understand that step S402 and the variation of it are not mutually exclusive. For example, the slave device may be capable of displaying certain prescribed verification signal or physical property and at the same time has a button. The verification operation prompt may be sent by the verification server to the master terminal to prompt the master terminal to record verification signal or physical property output or displayed by the slave device and at the same time prompt the user of the master terminal to press the button on the slave device in a certain prescribed manner. Correspondingly, the slave device may be instructed by the verification server to display certain verification signal or physical property and to simultaneously monitor how its button is being pressed.

In some other implementation, the operation instruction for displaying the verification signal or physical property by the slave device includes but is not limited to one or more of displaying a random number, displaying a random character, displaying a graphic pattern, displaying a phrase, controlling a color of an indicator light, controlling the number of indicator lights, controlling a flashing frequency of an indicator light, controlling a voice output, inducing a physical deformation, and generating a physical displacement.

In some embodiment, the method of FIG. 4 and its variation may further include: (1) determining validity of the verification information by the verification server after receiving the verification information containing observed verification signal or physical property sent by the master terminal and/or the verification information sent by the slave device containing the actual manipulation of the slave device (such as pressing of a button); (2) sending a permission result to the master terminal according to a verification result. For example, if the operation instruction for displaying the verification signal or physical property sent to the slave device is displaying a number 567, and the verification information reported by the master terminal is a non-matching number 345, the verification fails and thus the master terminal cannot obtain permission to control the slave device. As another example, if the received verification information sent from the slave device is that its button was pressed three times, and the verification operation prompt sent to the master terminal is pressing the button of the slave device three times, the verification would be successful and thus the master terminal may obtain permission to control the slave device. When verifying the verification information, it may also be detected by the verification server whether this verification information is received within a preset period of time. If this verification information is received beyond the preset period, this verification information may be considered stale and invalid.

In another embodiment, the method above further includes establishing by the verification server a control relationship of the current account for the master terminal over the slave device if the verification is successful. The control relationship may be stored in the verification server after it is being established and is associated with the master terminal, such that the current account for the master terminal obtains permission of controlling the slave device in a long term basis until they are unbound later. In such a way, a subsequent request by the master via its account to control the slave device may be granted without further verification.

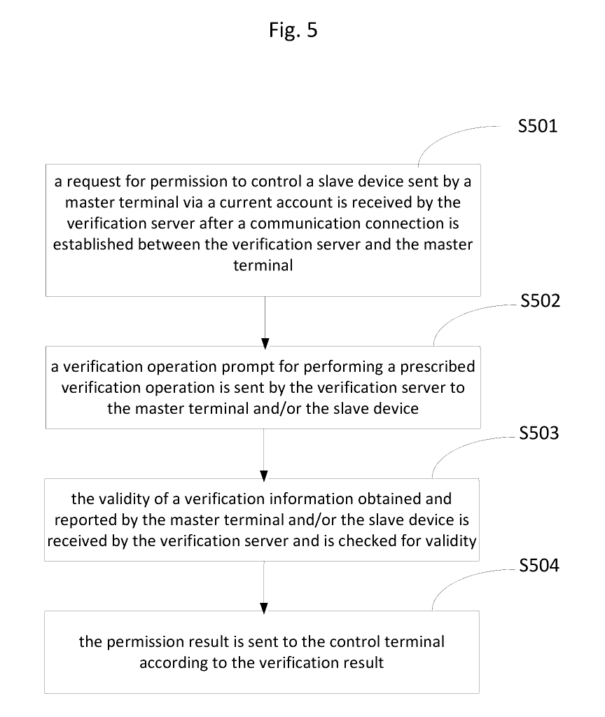

In another specific example, the master device may be a tablet or Pad device (herein referred to as “Pad”) and the slave device may be a smart outlet or a smart charger (herein referred to as “smart outlet”). The pad may attempt to obtain a permission to operate the smart outlet. The verification process and granting of permission by the verification server is shown in the flow chart in FIG. 5.

In step S501, a request for permission to control sent by the master terminal, the Pad, via the current account is received by the verification server after the communication connection is established between the Pad and the verification server. In step S502, the verification server sends the Pad a verification operation prompt for recording the verification signal or physical property output or displayed by the slave device and/or a verification operation prompt for manipulating of the slave device. For example, a prompt of “please input the color of the indicator light” and/or “please push the red button three times within 2 seconds” may be sent to the Pad. At approximately the same time, the verification server may send operation instruction to the smart outlet for displaying the verification signal or physical property that the Pad is prompted to observe (such as displaying blue in its indicator) and record. The verification server may alternatively or additionally send instruction to the smart outlet to detect and report any manipulation performed on it (such as pressing of its button). In step S503, the verification server verifies the verification information recorded and reported by the Pad and/or the smart outlet. For example, when the binding operation prompt is “please input the color of the indicator light” and the verification information reported by the Pad is blue, the verification would be successful. The verification server may further determine whether the verification information is reported within a preset period of time. If a verification information is received beyond the preset period, it is deemed stale and invalid. In step S504, a permission result is sent to the Pad according to the verification result. When the verification is successful, the control relationship between the current account of the Pad and the smart outlet is established.

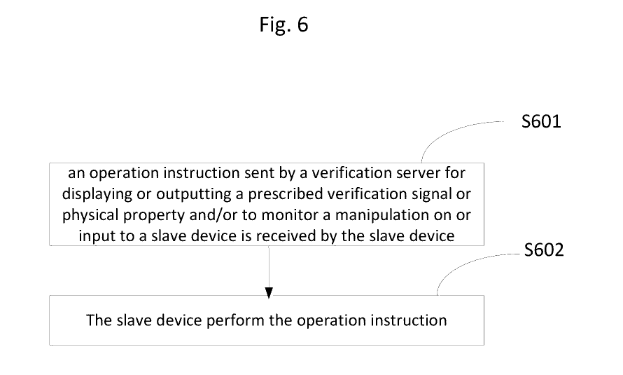

Based on the general principle of this disclosure, FIG. 6 shows a flow chart of a method for verifying permission as applied to a slave device. The slave device may be of any kind. For example, the slave device maybe a smart outlet, a smart camera, a smart purifier, and a smart air conditioner. The method may comprise the following steps.

In step S601, a verification operation instruction for displaying a verification signal or physical property sent by the verification server is received by the slave device. Alternatively or additionally, the slave device may receive instruction to monitor a prescribed manipulation of or input into the slave device. In step S602, the slave device displays the corresponding verification signal or physical property and/or monitors any occurrence of the prescribed manipulation or input in response to the operation instruction.

The operation instruction for displaying verification signal or physical property may include one or more of displaying a random number, displaying a random character, displaying a graphic pattern, displaying a phrase, controlling a color of an indicator light, controlling the number of indicator lights, controlling a flashing frequency of an indicator light, controlling a voice output, a physical deformation and a physical displacement. Instructions for displaying other physical properties are also contemplated

In one embodiment, the method of FIG. 6 as applied to the slave device may further include sending or reporting verification information by the slave device to the verification server after monitoring the manipulation performed on the slave device or input into the slave device. For example, a prescribed manipulation may be pressing a button of the slave device in a prescribed manner or operating a remote control of the slave device in a prescribed manner. A prescribed input into the slave device may be a voice input and image input. The slave device in this step thus sends or reports any detected button push, remote control operations, voice input or image input to the verification server.

The method provided by embodiments above allows for permission verification based on physical properties of the slave device. It may simplify the verification operation because the user (of the master terminal and the slave device) may be verified by, for example, a simple button push or a simple input of an observed verification signal or physical property. Because this verification is at least initially (the first time the control relationship is established for the account of the master terminal to control the slave device) based on physical proximity between the master terminal and the slave device, security may be improved over a verification procedure involving passing verification codes between the verification server and the master terminal. For example, if only verification codes are used, a third party terminal device having no permission may discover the slave device and intercept the verification code and obtain control over the slave device. Further, because the prescribed verification signal or physical property to be output or displayed by or manipulation on or input into the slave device may be dynamic, the security is further improved.

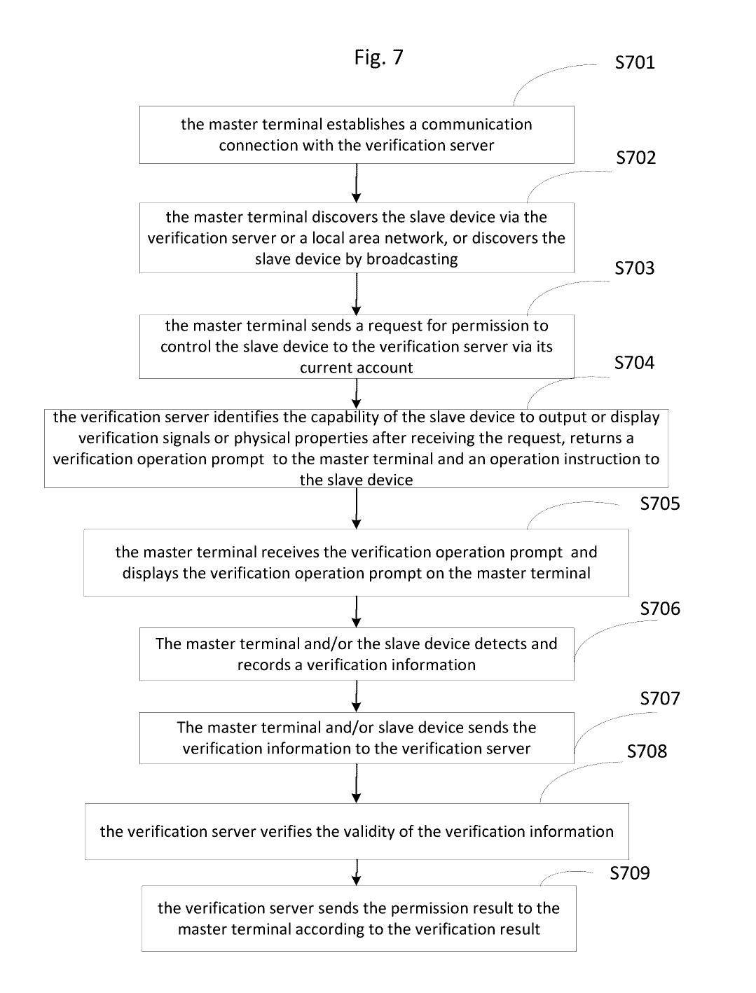

FIG. 7 is a flow chart showing a system level method for verifying permission according to an illustrative embodiment. The system includes a master terminal, a slave device, a verification server and the networks that provide communication links between them. As shown in FIG. 7, the method may include the following steps.

In step S701, the master terminal establishes a communication connection with the verification server. In step S702, the master terminal discovers the slave device via the verification server or a local area network, or discovers the slave device by broadcasting. For example, when using the local area network, the master terminal may establish a communication connection with a router that provides the local area network, and discovers the slave device using broadcasting messages via the router. In step S703, the master terminal sends the binding request to the verification server via its current account with the verification server.

In step S704, the verification server identifies the verification signal or physical property and capability of the slave device after receiving the request for permission to control, and returns a verification operation prompt to the master terminal. The verification operation prompt may comprise instruction to prompt the master terminal to perform at least one of (1) observing and recording a prescribed verification signal or physical property output or displayed by the slave device, or (2) carrying out a prescribed manipulation of the slave device or input a prescribed signal into the slave device. For the later, as an example, the operation prompt may be a prompt for pressing a button on the slave device in a particular manner, operating a remote control for the slave device in a particular manner, inputting a particular voice or speech into the slave device, operating the electromagnetic induction switch on the slave device, etc.

In step S705, the master terminal receives the verification operation prompt and displays the binding operation prompt to the user of the master terminal. Optionally in step S705, the slave device receives operation instruction to display the prescribed verification signal or physical property and/or to monitor the prescribed manipulation or input.

In step S706, the slave device and/or the master terminal detect and record a verification information. For example, the slave device may detect and record the manner its button was pressed, the operation performed on its remote control, the content of a voice speech input into the slave device, the manner it was displaced, moved, or deformed, etc. Additionally or alternatively, the master terminal may observe and record (via its user or its sensors, such as cameras) the verification signal or physical property output or displayed by the slave device For example, the master terminal may observe and record a random number output or displayed, a particular color flashed, a particular voice made, a particular graphic pattern output or displayed, etc., by the slave device.

In step S707, the slave device and/or the master terminal send the recorded verification information to the verification server. In step S708, the verification server verifies the validity of the verification information after receiving the verification information sent by the slave device and/or the master terminal. When verifying the validity, the verification may further determine whether the verification information is received within a preset period of time. If this verification information is received beyond the preset period, it is deemed stale and invalid. Finally in step S709, the verification server sends the permission result to the master terminal according to the verification result. If the verification is successful, the control relationship between the current account of the master terminal and the slave device may be established.

With the method provided by the embodiment above, the control relationship between the account of the master terminal and the slave device is established based on proximity between the master terminal and the slave device and the method thus provides improved security and helps avoiding abuses by malicious users.

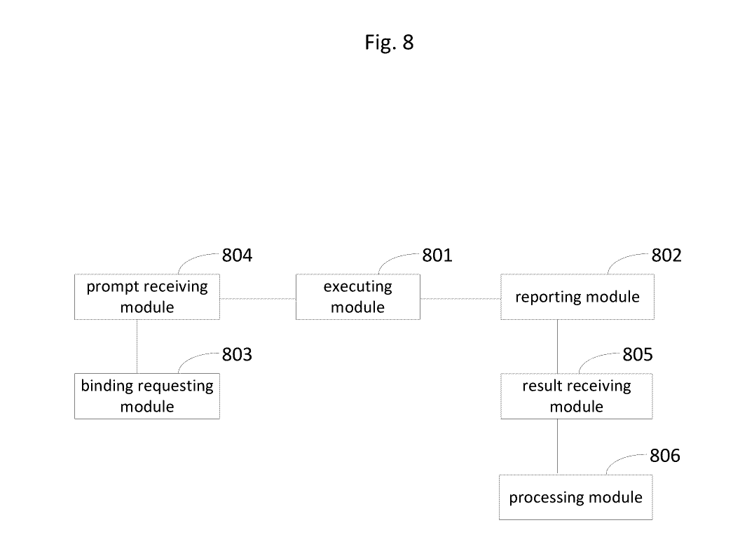

The present disclosure further provides a device for verifying permission based on the method embodiments above. As shown by the block diagram in FIG. 8, the device includes an executing module 801 and a reporting module 802. The executing module 801 is configured to execute a binding verification operation according to a verification signal or physical property output or displayed in a slave device. The reporting module 802 is configured to report verification information of the executed binding verification operation to a verification server. The device may further include a binding requesting module 803 and a prompt receiving module 804. The binding requesting module 803 is configured to send a binding request to the verification server via a current account after establishing a communication connection with the slave device. The prompt receiving module 804 is configured to receive a binding operation prompt for the verification signal or physical property of the slave device returned by the verification server.

The device may further include a result receiving module 805 and a processing module 806. The result receiving module 805 is configured to receive a binding result returned by the verification server according to the verification information. The processing module 806 is configured to establish a control relationship between the current account and the slave device if the binding result is successful, and to display a binding failure prompt if the verification fails.

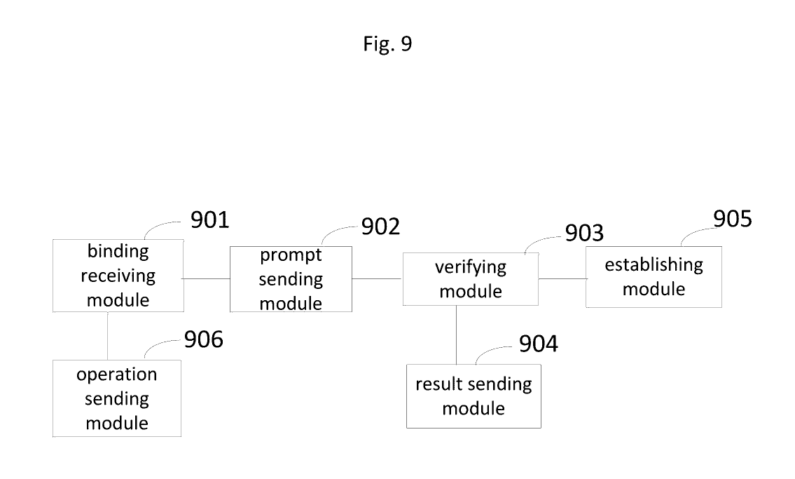

This disclosure further provide a device for verifying permission as shown in FIG. 9, the device includes a binding receiving module 901 and a prompt sending module 902.

The binding receiving module 901 is configured to receive a binding request sent by the master terminal via a current account after establishing a communication connection with a master terminal. The prompt sending module 902 is configured to send a binding operation prompt for a verification signal or physical property of a slave device to the master terminal. The device further includes a verifying module 903 and a result sending module 904. The verifying module 903 is configured to verify a validity of verification information after receiving the verification information of an executed binding verification operation that is sent by the master terminal and/or the slave device. The result sending module 904 is configured to send a binding result to the master terminal according to a verification result. The device may further comprise an establishing module 905 configured to establish a control relationship between the current account and the slave device if the verification result is valid. The device further includes an operation sending module 906 configured to send an operation instruction for displaying the verification signal or physical property to the slave device meanwhile sending the binding operation prompt for the verification signal or physical property of the slave device to the master terminal.

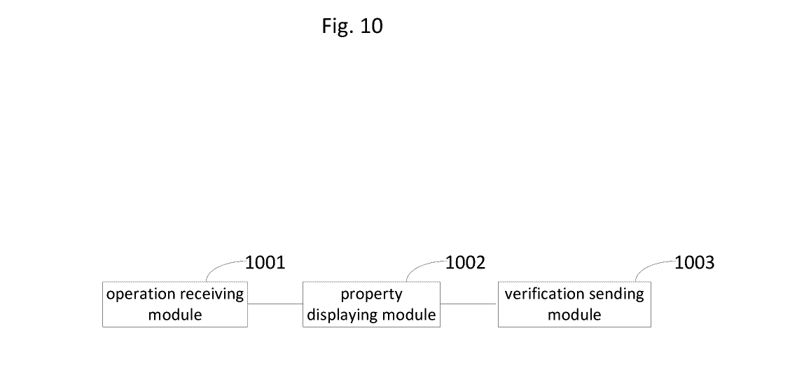

The disclosure provide further provide a device for verifying permission as shown in FIG. 10. The device may include an operation receiving module 1001 and a property displaying module 1002. The operation receiving module 1001 is configured to receive an operation instruction for displaying a verification signal or physical property sent by a verification server. The property displaying module 1002 is configured to display a corresponding verification signal or physical property according to the operation instruction. The device may further includes a verification sending module 1003 configured to send verification information to the verification server after receiving a binding verification operation for the verification signal or physical property.

With respect to the devices in the above embodiments of FIGS. 8. 9 and 10, the specific manners in which each individual module, submodule or unit operates have been described in detail in the corresponding method embodiments of FIGS. 1-7.

The present disclosure further provides another device for verifying permission. The device comprises a processor; a memory configured to store an instruction executable by the processor; wherein the processor is configured to perform at least one of the methods described in FIG. 1-7.

A non-transitory computer-readable storage medium is further disclosed. The storage medium have stored therein instructions which, when executed by a processor of a terminal, cause the terminal to perform at least the methods for verifying permission described in FIGS. 1-7,

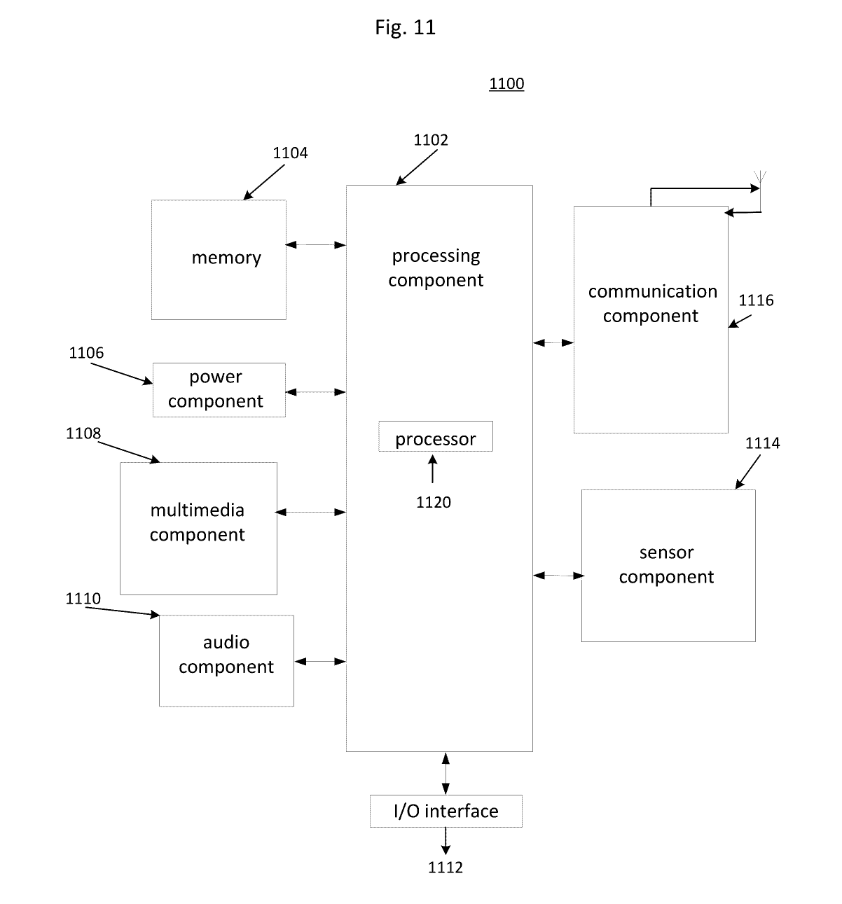

FIG. 11 is a block diagram showing a device 1100 for verifying permission according to an illustrative embodiment. For example, the device 1100 may be a mobile phone, a computer, a digital broadcast terminal, a messaging device, a gaming console, a tablet, a medical device, exercise equipment, a personal digital assistant, and the like.

Referring to FIG. 11, the device 1100 may include one or more of the following components: a processing component 1102, a memory 1104, a power component 1106, a multimedia component 1108, an audio component 1110, an input/output (I/O) interface 1112, a sensor component 1114 and a communication component 1116.

The processing component 1102 controls overall operations of the device 1100, such as the operations associated with display, telephone calls, data communications, camera operations, and recording operations. The processing component 1102 may include one or more processors 1120 to execute instructions so as to perform all or a part of the steps in the above described methods. Moreover, the processing component 1102 may include one or more modules which facilitate the interaction between the processing component 1102 and other components. For instance, the processing component 1102 may include a multimedia module to facilitate the interaction between the multimedia component 1108 and the processing component 1102.

The memory 1104 is configured to store various types of data to support the operation of the device 1100. Examples of such data include instructions for any applications or methods operated on the device 1100, contact data, phonebook data, messages, pictures, videos, etc. The memory 1104 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1106 is configured to provide power to various components of the device 1100. The power component 1106 may include a power management system, one or more power sources, and other components associated with the generation, control, and distribution of power in the device 1100.

The multimedia component 1108 includes a display screen configured to provide an output interface between the device 1100 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1108 includes a front camera and/or a rear camera. The front camera and the rear camera may receive an external multimedia datum when the device 1100 is in an operation mode such as a photographing mode or a video mode. Each of the front camera and the rear camera may be a fixed optical lens system or have focus and optical zoom capability.

The audio component 1110 is configured to output and/or input audio signals. For example, the audio component 1110 includes a microphone (MIC) configured to receive an external audio signal when the device 1100 is in an operation mode, such as a call mode, a recording mode, and a voice recognition mode. The received audio signal may be further stored in the memory 1104 or transmitted via the communication component 1116. In some embodiments, the audio component 1110 further includes a loud speaker to output audio signals.

The I/O interface 1112 is configured to provide an interface between the processing component 1102 and peripheral interface modules, such as a keyboard, a click wheel, buttons, and the like. The buttons may include, but are not limited to, a home button, a volume button, a starting button, and a locking button.

The sensor component 1114 includes one or more sensors to provide status assessments of various aspects of the device 1100. For instance, the sensor component 1114 may detect an on/off status of the device 1100, relative positioning of components (e.g., a display screen and a keypad) of the device 1100. The sensor component 1114 may further detect a change in position of the device 1100 or a component of the device 1100, a presence or absence of user contact with the device 1100, an orientation or an acceleration/deceleration of the device 1100, and a change in temperature of the device 1100. The sensor component 1114 may include a proximity sensor configured to detect the presence of nearby objects without any physical contact. The sensor component 1114 may further include a light sensor, such as a CMOS or CCD image sensor, for use in imaging applications. In some embodiments, the sensor component 1114 may also include an accelerometer sensor, a gyroscope sensor, a magnetic sensor, a pressure sensor, or a temperature sensor or thermometer.

The communication component 1116 is configured to facilitate a wired or wireless communication between the device 1100 and other terminals. The device 1100 can access a wireless network based on a communication standard, such as Wi-Fi, 2 G, 3 G, LTE, or 4 G cellular technologies, or a combination thereof. In one illustrative embodiment, the communication component 1116 receives a broadcast signal or broadcast associated information from an external broadcast control system via a broadcast channel. In one illustrative embodiment, the communication component 1116 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, or other technologies.

In illustrative embodiments, the device 1100 may be implemented with one or more electronic elements such as application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In illustrative embodiments, there is further provided a non-transitory computer readable storage medium including instructions, such as the memory 1104 including instructions executable by the processor in the device 1100 to perform the above-described methods. For example, the non-transitory computer-readable storage medium may be a ROM, a RAM, a CD-ROM, a magnetic tape, a floppy disc, an optical data storage device, and the like.

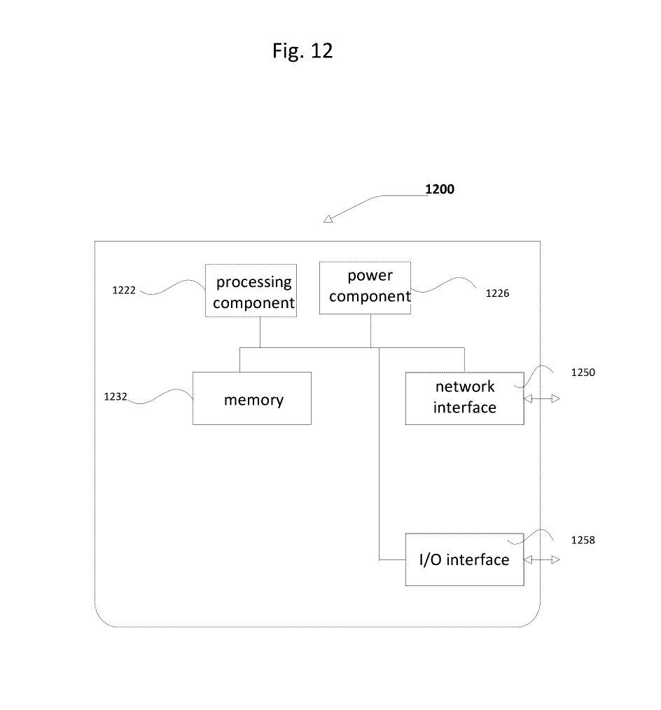

FIG. 12 is a block diagram of a device 1200 for verifying permission, according to an illustrative embodiment. For example, the device 1200 may be a server. Referring to FIG. 12, the device 1200 may include a processing component 1222 which further include one or more processors, and a memory resource represented by a memory 1232 and configured to store instructions executable by the processing component 1222, such as application programs. The application programs stored in the memory 1232 may include one or more modules, in which each module corresponds to a set of instructions. Further, the processing component 1222 may be configured to execute instructions so as to perform the above methods.

The device 1200 may also include a power component 1226 configured to execute a power management of the device 1200, a wired or wireless network interface 1250 configured to connect the device 1200 to the internet, and an input/output interface 1258. The device 1200 may be operated based on an operating system stored in the memory 1232, such as Windows Server™, Mac OS X™, Unix™, Linux™, FreeBSD™, or the like.

Each module or unit discussed above for FIG. 8-10, such as the executing module, the reporting module, the prompt receiving module, the binding requesting module, the executing module, the reporting module, the result receiving module, the processing module, the binding receiving module, the prompt sending module, the verifying module, the result sending module, the establishing module, the binding receiving module, the operation sending module, the operation receiving module the property display module, and the verification sending module may take the form of a packaged functional hardware unit designed for use with other components, a portion of a program code (e.g., software or firmware) executable by the processor 1120 or 1222 or the processing circuitry that usually performs a particular function of related functions, or a self-contained hardware or software component that interfaces with a larger system, for example.

The illustrations of the embodiments described herein are intended to provide a general understanding of the structure of the various embodiments. The illustrations are not intended to serve as a complete description of all of the elements and features of apparatus and systems that utilize the structures or methods described herein. Other embodiments of the disclosure will be apparent to those skilled in the art from consideration of the specification and practice of the embodiments disclosed herein. This application is intended to cover any variations, uses, or adaptations of the disclosure following the general principles thereof and including such departures from the present disclosure as come within known or customary practice in the art. It is intended that the specification and examples are considered as exemplary only, with a true scope and spirit of the invention being indicated by the following claims in addition to the disclosure

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

What is claimed is:

1. A method for obtaining permission to control a slave device by a master terminal from a verification server, comprising:
sending by the master terminal a request for permission to control the slave device to the verification server via a current account of the master terminal registered with the verification server after the master terminal has established a communication connection with the slave device;
receiving a verification operation prompt by the master terminal from the verification server informing the master terminal to record a verification signal to be output by the slave device;
executing a verification operation comprising at least recording by the master terminal the verification signal currently output by the slave device as a verification information; and
reporting the verification information to the verification server,
wherein the verification signal to be output by the slave device is prescribed by the verification server and dynamically controllable by the slave device.

2. The method according to claim 1, further comprising:
receiving a permission decision from the verification server wherein the permission decision is made by the verification server in response to the reported verification information;
establishing a control relationship between the current account and the slave device if the permission decision is positive; and
displaying a permission failure prompt if the permission decision is negative.

3. The method according to claim 1, wherein the prescribed verification signal to be output by the slave device comprises at least one of a prescribed random number, random character, graphic pattern, phrase, indicator color, number of indicators, flashing frequency of an indicator, voice output, physical deformation, or physical displacement.

4. A method for verifying, by a verification server, permission for controlling a slave device by a master terminal, comprising:
receiving a request to control the slave device sent by the master terminal via a current account of the master terminal with the verification server after establishing a communication connection with the master terminal; and
sending a verification operation prompt to the master terminal for recording a verification signal output by the slave device,
wherein the verification signal to be output by the slave device is prescribed by the verification server and dynamically controllable by the slave device.

5. The method according to claim 4, further comprising:
receiving a verification information from the master terminal containing the recorded verification signal of the slave device by the master terminal;
verifying a validity of the reported verification information by comparing the reported verification information with the prescribed verification signal; and
sending a permission result to the master terminal according to validity of the verification information.

6. The method according to claim 5, further comprising establishing a control relationship between the current account of the master terminal and the slave device if the verification information is valid.

7. The method according to claim 4, further comprising:
sending an instruction for outputting the prescribed verification signal to the slave device substantially at the same time of sending the verification operation prompt to the master terminal.

8. The method according to claim 7, wherein the instruction for outputting the prescribed verification signal comprises at least one of outputting a prescribed random number, random character, graphic pattern, phrase, indicator color, number of indicators, flashing frequency of an indicator, voice output, physical deformation, or physical displacement.

9. A method for giving permission by a slave device to be controlled by a master terminal via a verification server, comprising:
receiving an instruction from the verification server for outputting a verification signal; and
outputting the verification signal according to the instruction,
wherein the verification signal is prescribed by the verification server and dynamically controllable by the slave device.

10. The method according to claim 9, wherein the prescribed verification signal comprises at least one of a prescribed random number, random character, graphic pattern, phrase, indicator color, number of indicators, flashing frequency of an indicator, voice output, physical deformation, or physical displacement.

11. A terminal device seeking permission to control a slave device, comprising:
a processor;
a memory configured to store an instruction executable by the processor;
wherein the processor is configured to cause the terminal to:
executing a verification operation comprising at least recording by the terminal a verification signal currently output on the slave device as a verification information; and
reporting the verification information to a verification server,
wherein the verification signal to be output by the slave device is prescribed by the verification server and dynamically controllable by the slave device.

12. The terminal according to claim 11, wherein the prescribed verification signal output by the slave device comprises at least one of a prescribed random number, random character, graphic pattern, phrase, indicator color, number of indicators, flashing frequency of an indicator, voice output, physical deformation, or physical displacement.
